(19) United States
(12) Patent Application Publication
(10) Pub. No.: US 2011/0208395 A1
(43) Pub. Date: Aug. 25, 2011

(54) METHOD AND DEVICE FOR CONTROLLING AN AUTOMATED GEARBOX

(75) Inventors: Bernd Doebele, Salem (DE); Norbert Wiencek, Hagnau (DE)

(73) Assignee: ZF Friedrichshafen AG, Friedrichshafen (DE)

(21) Appl. No.: 12/301,868

(22) PCT Filed: Apr. 25, 2007
(86) PCT No.: PCT/EP2007/054038

§ 371 Date: Nov. 21, 2008

(30) Foreign Application Priority Data
May 24, 2006 (DE) 102006024277.1

(51) Int. Cl. F16H 59/00

(52) U.S. Cl. 701/60

(57) ABSTRACT

The invention concerns a method and a device for controlling an automated transmission, in which a transmission control device is provided which, on the basis of input signals, emits to suitable actuators control signals which initiate a shift sequence of the automatic transmission.

To determine an optimum target gear for a shift process appropriate for the situation, it is provided that on the basis of the input signals the transmission control device first decides whether a traction force reduction of the driven wheels of the vehicle should be initiated and if the decision is positive the transmission control device emits signals which result in a defined traction force reduction of the drive wheels, the transmission control device then reads in traction force reduction data from which a change in the driving speed of the vehicle as a reaction to the traction force reduction can be derived, from the traction force reduction data it then forms a driving resistance magnitude which correlates directly with the current driving resistance of the vehicle, and finally, it takes this driving resistance magnitude into consideration when selecting the target gear.

This application is a national stage completion of PCT/EP2007/054038 filed Apr. 25, 2007, which claims priority from German Application Serial No. 10 2006 024 277.7 filed May 24, 2006.

### FIELD OF THE INVENTION

The invention concerns a method and a device for controlling an automated transmission.

### BACKGROUND OF THE INVENTION

For a long time automated transmissions have been used in vehicles of various types. For this purpose, such an automated transmission is actuated by a control device by way of suitable actuators. On the basis of an assessment of the driver's wishes and of the vehicle's behavior in relation to engine input parameters, the control device generates gear change commands and establishes the time at which the gear change required is to be carried out.

In practice, the speed of the vehicle, the engine speed, the engine power, the torque or similar parameters, the position of an accelerator pedal and, if need be, also the position of gear selector operating elements are read in and, on the basis of the condition at the time, or in some cases, also on the basis of the time development of the parameters, it is decided whether a gear change should take place. Correspondingly, a gear change can always be regarded as a strategy for avoiding or remedying a shortcoming in the form of a non-optimal gear.

Lately, in ordinary transmission control devices, specific limit values are monitored which, when reached or exceeded, trigger a defined action in the form of a gear change to a particular gear, depending on the limit value in question and the manner in which it has been exceed or not reached. In the known control systems, the action is then carried out “immediately”—i.e., without further delay in the sense of what is possible given the technical circumstances and within the ambit of reasonable technical solutions.

Improved variations of such a control device may involve a more anticipatory determination or preparation of a forthcoming gear change. This, however, changes nothing in the basic sequence that, before initiating a shift sequence on the basis of the data read in when threshold values are reached or exceeded, a specific shift sequence, for example an upshift to the next-higher gear, is determined. In improved transmission control methods, this only happens at a comparatively earlier time and on the basis of mathematical-technical models which enable a prognosis of operating conditions that are probable in the near future. Even with such methods, it is already determined which gear is to be shifted into, when a gear change has been initiated.

Although in the past, such control systems for automated transmissions have proved their worth in many respects, they still suffer from drawbacks.

For example, at present a decisive criterion for the selection of a gear or a gear change to be carried out is the power demanded from the vehicle's engine. Until now, this power has usually been determined on the basis of engine control tables or models of the engine control system from a number of directly measurable or otherwise known parameters, such as the engine speed, the ignition angle, the quantity of fuel injected and the fuel injection time.

In combination with known data concerning the transmission ratios of actual alternative gears and the speed of the vehicle, the control device of the automated transmission then determines one or more limit values such that, when they are reached, shifting to another gear brings advantages in relation to specific defined targets, such as fuel consumption, engine wear, the maximum ability to accelerate or the shifting frequency.

Alternatively, according to a simpler method, some important engine parameters can be monitored to detect the reaching of limit values so that if a rotation speed limit value has been reached, a corresponding gear change is carried out.

The actual power required at the vehicle's wheels, having regard to the current weight of the vehicle, the inclination of the road, the rolling resistance and the air resistance of the vehicle is in any event determined or taken into account in the methods, described above, in an elaborate manner involving intensive computation and are prone to error.

This is particularly relevant in the case of vehicles for the transport of goods since, with these the payload and the current power demand varies markedly as a function of road inclination and rolling resistance while, at the same time, a relatively high wind resistance combined with the wind speed and wind direction currently acting on the vehicle can have a considerable influence on an optimum gear change.

For example, with the previous transmission control systems, it can happen that in a heavily loaded goods vehicle on a slope, when a certain engine speed limit or other parameter is reached, a shift to the next-higher gear is triggered. Owing to the traction force interruption that is unavoidable during gearshifts in almost any type of transmission, the previously determined target gear may no longer be optimal because the vehicle's speed has meanwhile decreased considerably and the ability of the vehicle to accelerate may be too small because of the resulting low engine speed.

In very unfavorable operating situations, especially with the traffic at construction sites or on steep ramps, it is even possible that the target gear either can no longer be engaged at all, because the speed of the drive engine has fallen below its minimum or that the power supplied by the drive engine in the target gear is not sufficient to at least maintain the speed of the goods vehicle. In such cases, either an immediate, new gear change takes place or the shift process is discontinued, with a correspondingly extended traction force interruption. In both cases, particularly on steep ramps and with a heavy load, it is possible that a downshift to the original gear at that time is no longer sufficient.

In the most favorable case, this is recognized by the transmission control unit and from the beginning, a downshift is carried out through at least two gears. In the least favorable case, a new shift attempt takes place which, because the vehicle has meanwhile slowed down, further again has to be discontinued so that ultimately the vehicle is braked to rest or may even roll backward. The subsequent restart that then has to be carried out under full load on a steep ramp which results in considerable and costly wear, even with modern and robust clutches.

To avoid this problem, until now mostly inadequate solutions have been proposed, which either compel modified shift behavior in certain cases with the help of often costly additional sensors for determining the loading and the road inclination or which rely on prompt manual intervention by the driver in that, for example, he manually suppresses a shift to a higher gear.

Against this background, the purpose of the present invention is to propose a control method for an automated transmission with which, in a simple manner, the drive power actually necessary in order to keep the driving speed constant is taken into account when determining the gear to be selected. A further purpose of the invention is to disassociate the selection of a target gear in time from the initiation of a gear change and thereby to enable greater flexibility and a target gear selection that is more appropriately timed and therefore better matched to the situation.

### SUMMARY OF THE INVENTION

The invention is based on the recognition that the drive power, needed in order to keep the vehicle's speed constant, can be determined accurately enough, in a simple way, by reducing the power of the drive engine by a defined amount or to zero and determining the resulting speed change of the vehicle.

In what follows, for the sake of brevity, this power needed for keeping the driving speed constant will also be referred to as the “constant power”, which is a magnitude proportional to the driving resistance. This constant power enables a more appropriate and later-timed selection of a target gear to be engaged and thus enables shifting behavior which is optimized in accordance with the target magnitudes chosen.

In this context, the constant power does not need to be a power in the physical sense, but rather need only stand in a known and simplest possible relation to the physically necessary power for keeping the speed constant. Instead of a determined work per unit time, a work per unit distance can also be determined which, on account of the known driving speed, can either easily be converted to a work per unit time or can also be processed directly in a corresponding program. In addition, other parameterizations of the constant power are also conceivable, which have it in common, however, that they are based on the speed decrease of the vehicle that results from a defined reduction of the drive power and the effect of the current driving resistance.

Accordingly, the invention starts from a method for controlling an automated transmission in which a transmission control device is provided which, on the basis of input signals, generates suitable actuator control signals that initiate a shift sequence of the automated transmission.

To provide a clear definition of the scope of the protection claimed, below are some key terms defined in more detail, which are central for describing the invention.

The actuators mentioned above include, besides those actuators directly involved in adjusting the transmission ratio of the automated transmission, in most cases also further actuators with the help of which the torque transfer, between the drive engine and the driven wheels of the vehicle, can be controlled, as well as actuators which can vary the power output of the drive engine as desired.

In the context of these explanations, it does not matter whether a clutch actuator for a friction clutch, between the drive engine and the automated transmission, is actuated directly by a signal from the transmission control device or whether the latter only emits a signal to a further control device which converts the signal and processes it, if need be, with the help of other input magnitudes and then for its part emits a signal to the clutch actuator. This applies all the more so to actuators that can vary the power output of the drive engine as desired. Those actuators, which set the position of a throttle valve or determine the quantity of a fuel injected, are usually controlled by a separate engine control unit. In the context of the present document, however, the reference is only to the (in this case indirect) output of signals that influence the control parameters of the actuators, regardless of whether this signal production takes place directly or via any intermediate stages and, if necessary, having regard to other parameters.

The term “actuator” should be interpreted correspondingly broadly. Actuators that engage directly with the automated transmission mostly comprise electric motor or hydraulic or pneumatic active components such as a piston-cylinder arrangement which, on the basis of an information signal and with the help of external energy, brings about a change of a mechanical magnitude. Thus, an adjustment device for an ignition angle or a device for adjusting the quantity injected or the injection timing counts as an actuator, since these can influence the power output of the drive engine directly on the basis of an information signal and by the use of external energy.

A shift sequence is understood to mean, in the majority of cases, the disengagement of a transmission gear and the subsequent engagement of a gear. During this, ordinary automated transmissions undergo a traction force interruption, in particular a break of the drive train due to the opening of a friction clutch and a condition in which the transmission is neutral in which no transmission gear is active and correspondingly no torque transfer takes place by the automated transmission.

A shift sequence usually comprises, in a first part-sequence, the regulation of the drive engine to reduce its drive power, an interruption of the drive train by opening a friction clutch, the disengagement of the previously active gear and thus the shifting of the transmission to its neutral position. In a second part-sequence, starting from the neutral position, a gear is engaged and the drive engine is controlled so that a synchronous rotation speed is reached in the transmission or a desired power can be provided and the friction clutch is then engaged.

In the present document, however, a shift sequence can also consist of one of these first and second part-sequences, for example if rolling of the vehicle under no drive power is desired, namely either with the clutch disengaged and/or with the transmission in its neutral position or if that condition is to be terminated.

To achieve the stated objective in terms of method, it is provided that the transmission control device first decides on the basis of input signals whether a traction force reduction of the driven wheels of the vehicle should be initiated. If this is the case, it emits signals that result in a defined traction force reduction of the driven wheels. As already indicated, in most cases, this can simply be done by disengaging the clutch or by shifting the transmission into neutral, although in both cases the drive engine power should be reduced and this may be sufficient even without disengaging the clutch or shifting the transmission to its neutral position.

The transmission control device then reads in the traction force reduction data, from which a change of the vehicle's speed as a reaction to the traction force reduction can be derived. These data can be the rotation speed of a vehicle wheel, the speed of the drive engine produced when the clutch is engaged and a gear engaged in reaction to a drive power reduction or a change of some other suitable rotation speed in the drive train or their respective variations with time.

From this, the transmission control device forms a driving resistance magnitude directly correlated with the current driving resistance of the vehicle, for example the aforesaid constant power, and then takes this driving resistance magnitude into account for the selection of a target gear to be engaged.

As already explained for the constant power, in this case it is not necessary to determine a magnitude defined physically as the driving resistance. For the sake of clarity, however, in what follows it will be assumed that the transmission control device determines a magnitude that expresses the driving resistance directly in the form of a power to be applied to the transmission input in order to keep the driving speed constant, i.e., a constant power.

The advantages of the method described are mainly based on the fact that in a simple manner and with minimal effort, the transmission control device determines a magnitude correlated with the current driving resistance, which can be called upon directly for selecting the optimum target gear to be engaged. The driving resistance thus takes into account various factors such as the vehicle loading at the time, the inclination of the road and the air resistance and the rolling resistance at the time which, in turn, depends on the tires, the driving speed, the loading and the road condition.

In this it is, of course, possible that to reduce the overall shifting time, already before or on initiating the first part-sequence of the shifting process the target gear most probably to be selected is prepared for the shift. It is decisive, however, that the transmission control device makes the actual decision about the target gear to be engaged only on the basis of or at least after taking into account the constant power or the driving resistance value determined.

In this way, in the situations outlined earlier for heavy loading and on a steep ramp, it is entirely possible that on the basis of the extremely high constant power required it may be necessary to re-engage the previously active gear immediately or, owing to the intermediate slowing of the vehicle, even to select a gear that is lower compared to the previously active gear.

Likewise, in this way during an accelerating drive on a downhill road when the driving resistance is low or even when the driving resistance is negative, the transmission control device can carry out an upshift through two gear steps, even though this would not be advisable on a flat road under the same conditions.

A further development of the method according to the invention envisages that the traction force reduction amounts to a complete or almost complete interruption of the traction force. This can be done particularly simply by opening the friction clutch, between the drive engine and the automated transmission, or also by shifting the automated transmission to its neutral position. This enables the driving resistance to be determined in a particularly simple way since, in calculating it from the time variation of the vehicles speed, no additional torques of the drive engine need to be taken into account, which are, in any case, often not accurately known and, if an additional aggregate is started up during a shift sequence, can undergo large short-term fluctuations.

As an alternative to disengaging a friction clutch or shifting the automated transmission to neutral, the transmission control device can effect the traction force reduction by bringing about a reduction in the quantity of energy supplied to a drive engine per unit time. This enables a particularly early determination of the driving resistance or constant power and, in addition, a particularly rapid reaction to a possibly pronounced deceleration of the vehicle. For this, it must of course be ensured that a speed transfer, between the driven wheels and the drive output shaft of the drive engine, takes place at a known transmission ratio, i.e., in particular that the friction clutch is engaged and the automated transmission is not shifted to its neutral position.

Particularly when the drive engine is an internal combustion engine, such as a diesel or Otto engine, and the amount of energy supplied per unit time is reduced by reducing the quantity of fuel supplied to it, the traction force reduction can be brought to an end again within a very short time by increasing the quantity of fuel injected. This ensures that the reduction of speed during the traction force reduction can, if necessary, be minimized and, when the vehicle is operated in a gear with power still just sufficient for keeping the speed constant, that no downshift is needed on account of too great a loss of speed.

The transmission control device can bring about the traction force reduction of the drive engine particularly simply by adjusting the ignition angle and/or by changing the injection timing and/or by changing the number of cylinders ignited. These options are usually provided in any case in the engine control system and, therefore in general, only require a corresponding command from the transmission control device.

Another version of the method provides that the transmission control device brings about the traction force reduction of the drive engine by disengaging the shiftable clutch between the drive engine and the automated transmission of the vehicle. This reliably excludes any influence by induced drive engine torques. Furthermore, in this case, it is sufficient for the transmission control device only to act upon the actuators of the friction clutch, between the drive engine and the transmission, which have to be actuated in any case and—unless this task is performed automatically by the engine control system—to effect a corresponding change of the control of the drive engine.

In this case, there is no need for a torque produced or reduced by the drive engine to be accurately determined and taken into account. Not least, this variation enables a particularly late and thus very up-to-date determination of a magnitude proportional to the driving resistance, which has an influence on the optimum transmission gear to be selected. This guarantees that, even when the operating conditions are varying markedly, as can happen for example on construction sites, the target gear will be selected in a particularly updated manner.

A further version of the method, according to the invention, provides that as the traction force reduction datum from which a change in the driving speed of the vehicle as a reaction to the traction force reduction can be derived, the transmission control device determines a rotation speed difference between a first time point shortly before the traction force reduction is initiated and a second time point when the traction force reduction has taken place. This rotation speed difference can basically be determined at any desired shaft, provided that the latter's behavior is at least substantially proportional to the driving speed of the vehicle during the relevant time period.

Since for the drive engine high-grade sensors are, in any case, always available for determining the rotation speed, from the standpoint of using sensors for more than one purpose, it is advantageous for the transmission control device to determine the rotation speed difference of a shaft which has a fixed rotation speed ratio relative to the engine speed. In this, it does not, of course, matter whether the specific rotation speed determined is that of a crankshaft, a camshaft, a drive output shaft of the drive engine or a clutch component coupled to the drive output shaft. In any event, by virtue of this direct or indirect consideration of the engine speed change, the determination of the vehicle's speed reaction to a traction force reduction can begin particularly early and therefore shorten the overall shifting time in the case of time-critical shift processes.

To determine the most up-to-date possible rotation speed difference value it is desirable for the transmission control device to choose as the first time point a time immediately before the traction force reduction begins and as the second time point a time immediately before the disengaging of a clutch located between the drive engine and the automated transmission. In this context, the expression “time point immediately before the disengaging of the clutch” is understood to mean that the speed determined at the moment when the clutch is disengaged has the necessary clear relation to the driving speed of the vehicle. Although this is fundamentally possible in the case of a clutch with non-negligible slip, in most cases it demands disproportionately large calculation effort.

Besides the formation of an arithmetical mean value between a start speed and an end speed, it is in any case possible and often also appropriate in order to improve the result for the transmission control device to determine the rotation speed difference taking into account the time variation of the rotation speed. This can be done by simple integration over time or even by a weighting that is varied over time.

In particular, when the operating conditions are changing rapidly, a stronger weighting of measured values more recent in time seems to be advantageous for the determination of the most optimal possible target gears. To improve the accuracy of the method, it is therefore proposed that the transmission control device determines the speed difference taking into account a time variation of the speed and/or that it applies rule-based corrections. For example, in this way a longer shift time for certain shift processes can be taken into account by a corresponding correction of the calculation procedure for a weighted speed difference.

Below, a transmission control device for implementing the method, in accordance with at least one of the variations described above, is described.

Besides the elements and connections usually found in transmission control units, which need no further explanation here, to carry out the function intended and described earlier this transmission control device comprises at least one signal output for initiating a traction force reduction and at least one signal input for determining a magnitude proportional to the driving speed. In addition, a determination device is provided for determining a driving resistance magnitude that correlates directly with the driving resistance of the vehicle. Finally, the transmission control device is configured such that it considers the driving resistance magnitude determined when selecting the gear to be activated.

Here, it is both possible and preferable that after determining the driving resistance, the transmission control device selects a gear which can deliver an engine power above the constant power by a certain factor at the speed of the drive engine existing at the time and which also satisfies other boundary conditions such as the lowest possible fuel consumption or the least possible emission of noise or pollutants.

However, to minimize the overall traction force, reduction time, it can also be provided that already before the traction force reduction begins a target gear is already selected by conventional means and, if necessary, also prepared for the shift. In that case, the determination of the driving resistance serves as a check or verification of the gear selected.

To determine the data required about the vehicle's speed change as a reaction to the reduction or interruption of the traction force, there are three different possibilities, each with specific advantages. These are explained in more detail below.

In a first variation of the transmission control device, it is provided that the signal input for determining a magnitude proportional to the driving speed is connected to a rotation speed sensor, which can determine and transmit a rotation speed to the transmission control device in an area between a side, facing toward the drive engine, of a clutch located between the drive engine and the automated transmission and a drive output shaft of the drive engine.

This makes it possible to determine the deceleration of the vehicle directly from the change of the engine speed. Furthermore, determination of the speed reaction is possible at a very early moment so that a particularly long time remains available for determining the optimum target gear without extending the shift time as a whole. Finally, if needs be, when an unexpected marked deceleration is detected, the duration of the traction force reduction can be kept very short.

A second variation provides that the signal input for determining a magnitude proportional to the driving speed is connected to a rotation speed sensor which can determine and transmit to the transmission control device a rotation speed in an area between a side, facing toward the transmission, of a clutch located between the drive engine and the automated transmission and an input shaft of the automated transmission.

This enables a complete interruption of the traction force by disengaging the clutch and thus a very simple determination of the slowing of the vehicle actually attributable to the driving resistance.

Finally, a third variation envisages that the signal input for determining the magnitude proportional to the driving speed is connected to a rotation speed sensor, which can determine and transmit to the transmission control device, a speed in an area between an output shaft of the automated transmission and a driven wheel of the vehicle.

Besides the advantages described earlier, this also offers the possibility of using rotation speed sensors in any case present as part of an ABS system and, in addition, also determining and evaluating relevant information about the change of the vehicle's speed at a particularly late point in time. Thus, in an extreme case it is possible, even during the engagement of a previously determined target gear, to select a target gear different from the one selected originally because of a change in the vehicle's deceleration that has occurred.

For all three variations, for the sake of completeness, it should be mentioned that the location descriptions chosen for the arrangement of the rotation speed sensor should, of course, be understood in the sense of the technical functions of the components. Thus, in speaking of an area up to a drive output shaft of the drive engine or of the automated transmission, it should be understood that rotation speed changes of elements in a fixed and known relation to those shafts are included in the range of protection. For example, the use of a camshaft rotation speed is a solution equivalent to the use of the crankshaft rotation speed.

Finally, let it be noted that the method and the corresponding device for it can be used to good advantage In road vehicles of any type. This also includes tracked vehicles and other types of vehicles. The invention always offers particular advantages when implemented for controlling an automated transmission of a vehicle which, at full load, has a low maximum vehicle-weight-related power. Particularly in the case of heavy-load vehicles in use on construction sites, the problem described at the start, namely an interruption of the traction force while on a steep slope with a subsequent erroneous gearshift, constitutes a critical problem which can be solved simply and elegantly with the help of the invention presented here.

A combination of the present invention with known further control methods and devices, in particular a combination with the widely known options for including various other parameters, especially ones relating to the drive engine and the accelerator pedal position or their variations with time, are of course included within the scope of the invention.

### BRIEF DESCRIPTION OF THE DRAWINGS

The invention will now be described, by way of example, with reference to the accompanying drawings in which:

FIG. 1 shows a flow chart of a method in simplified form, according to the invention.

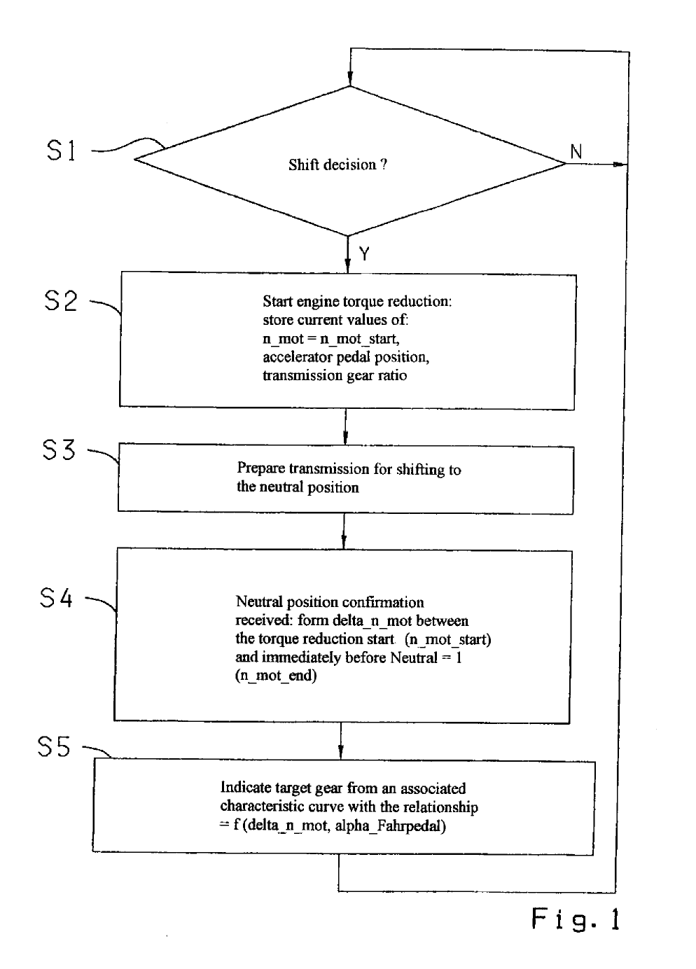

### DETAILED DESCRIPTION OF THE INVENTION

Accordingly, in this case the point of departure is a rotation speed measurement at the drive output shaft of the drive engine.

In process step S1 the transmission control device checks whether a shift decision is imminent. If a related characteristic is set to the value 1, this means that a shift should be carried out. If the answer to the question “Shift decision?” is “Yes”, this can be because absolute limit values have been exceeded, for example if the speed of a combustion engine has overstepped an upper or lower speed limit. Of course, besides such absolute limit values, derived limit values also come into consideration here, for example ones derived from the position of the accelerator pedal in relation to the driving speed or to the torque that can be provided by the drive engine.

Moreover, the characteristic of the “Shift decision?” variable can also be set to the value 1 by virtue of a manual input of a wish to change gear, or if certain other conditions are met. It is even possible for the “Shift decision?” variable to be set to the characteristic value 1 in certain operating ranges of the drive engine, for which an optimum gear cannot be indicated for all driving resistances, after the lapse of a certain time interval.

When the “Shift decision?” variable has the characteristic value 1, in step S2 the engine torque is reduced. For this, the relevant current values are first stored. Among other things, this makes it possible to revert quickly to the initial situation. The parameters stored are at least the rotation speed of the drive engine n_mot=n_mot_start, the accelerator pedal position and the current transmission gear ratio.

Then, in step S3 the transmission is prepared for shifting to its neutral position.

As soon as sensors indicate that the transmission is in neutral or the transmission control system can assume for other reasons—in the simplest case after the lapse of a certain time interval—that the transmission is in neutral, in process step S4 the speed difference delta_n_mot, between the engine speed n_mot_start stored in step S2 at the time when the torque reduction begins, and the engine speed n_mot end at the time immediately before the transmission responds with a signal that the torque connection between the driven wheels of the vehicle and the drive engine has been broken, is formed, this being denoted here as time point Neutral=1.

On the basis of this rotation speed difference delta_n_mot the transmission control device determines the target gear to be engaged. For this, other usual parameters are of course taken into account. These include in particular the position of the accelerator pedal alpha_Fahrpedal as the expression of the driver's desired speed or acceleration, and for example data about the transmission ratios of the individual gears and characteristic curves or other data concerning fuel consumption, about the speed and torque of the drive engine when the respective gear is selected, and about the respective engine speeds and required engine torques produced thereby.

It should be pointed out that assuming that the transmission control device does not ultimately re-activate the gear originally engaged, no traction force reduction in addition to or more prolonged by comparison with a conventional automated gear change takes place. In the event that the originally active gear is selected as the target gear, however, with conventional transmission control devices a considerably longer traction force interruption would be expected due to multiple shifting.

### REFERENCE NUMERALS

S1-S5 steps in the flow chart
n_mot rotation speed of the output shaft of the drive engine
n_mot_start rotation speed of the output shaft of the drive engine at the time point of step S2
n_mot_end rotation speed of the output shaft of the drive engine at the time point Neutral=1
delta_n_mot speed difference between n_mot_start and n_mot_end
alpha_Fahrpedal deflection of the accelerator pedal
Y yes; condition fulfilled
N no; condition not fulfilled

1-16. (canceled)

17. A method of controlling an automated transmission of a vehicle having a transmission control device which, depending on at least one input signal, transmits control signals to at least one actuator which initiate a shifting sequence of the automated transmission, the method comprising the steps of:
determining, with the transmission control device, if a reduction of traction force of driven wheels of the vehicle should be initiated depending on the at least one input signal;
transmitting the control signals, from the transmission control device to the at least one actuator, to initiate the reduction of the traction force of the driven wheels, if the transmission control device determines that the reduction of the traction force of the driven wheels should be initiated;
collecting traction force reduction data, with the transmission control device, and determining a driving resistance value of the vehicle depending on effects in the traction force reduction data caused by the reduction of the traction force of the driven wheels; and
selecting a target gear depending on the driving resistance value.

18. The method according to claim 17, further comprising the step of defining the reduction of the traction force of the driven wheels as an interruption in the traction force of the driven wheels.

19. The method according to claim 17, further comprising the step of initiating the reduction of the traction force of the driven wheels with the transmission control unit by reducing a quantity of energy supplied to a drive engine per unit time.

20. The method according to claim 19, further comprising the step of defining the drive engine as an internal combustion engine and reducing the quantity of the energy supplied per unit time by reducing a quantity of fuel delivered to the internal combustion engine.

21. The method according to claim 19, further comprising the step of defining the drive engine as one of a diesel engine and an Otto engine and reducing the quantity of the energy supplied, per unit time, by reducing a quantity of fuel injected in the one of the diesel engine and the Otto engine.

22. The method according to claim 20, further comprising the step of initiating the reduction of the traction force of the driven wheels with the transmission control device by at least one of adjusting an ignition angle, changing injection timing and changing a number of cylinders ignited.

23. The method according to claim 17, further comprising the step of initiating the reduction of the traction force of the driven wheels with the transmission control device by disengaging a shiftable clutch located between a drive engine and the automatic transmission of the vehicle.

24. The method according to claim 17, further comprising the step of determining, with the transmission control device, a rotational speed difference between a first time point before initiation of the reduction of the traction force of the driven wheels and a second time point after the reduction of the traction force of the driven wheels and defining the rotation speed difference as at least one of the traction force reduction data.

25. The method according to claim 24, further comprising the step of determining the rotation speed difference of a shaft having a fixed rotation speed ratio relative to a speed of an engine.

26. The method according to claim 24, further comprising the step of defining the first time point as a time point immediately before initiation of the reduction of the traction force of the driven wheels and the second time point as a time point immediately before disengaging a clutch located between a drive engine and the automated transmission.

27. The method according to claim 24, further comprising the step of considering rule-based corrections when determining the rotation speed difference.

28. A transmission control device for controlling an automated transmission of a vehicle by determining with the transmission control device, if a reduction of traction force of driven wheels of the vehicle should be initiated depending on the at least one input signal; transmitting the control signals from the transmission control device to the at least one actuator to initiate the reduction of the traction force of the driven wheels, if the transmission control device determines that the reduction of the traction force of the driven wheels should be initiated; collecting traction force reduction data with the transmission control device and determining a driving resistance value of the vehicle depending on effects in the traction force reduction data caused by the reduction of the traction force of the driven wheels; and selecting a target gear depending on the driving resistance value, the transmission control device comprises:
at least one signal output for initiating the traction force reduction and at least one signal input for determining a magnitude proportional to driving speed, a determination device for determining a driving resistance magnitude which correlates directly with the driving resistance of the vehicle, the driving resistance magnitude being considered by the transmission control device when selecting the gear to be activated.

29. The transmission control device according to claim 28, wherein the signal input for determining the magnitude proportional to the driving speed is connected to a rotation speed sensor, which determines and transmits to the transmission control device a rotation speed, in an area between a side, facing away from the automated transmission, of a clutch located between a drive engine and the automated transmission, and a drive output shaft of the drive engine.

30. The transmission control device according to claim 28, wherein the signal input for determining the magnitude proportional to the driving speed is connected to a rotation speed sensor, which determines and transmits to the transmission control device, a rotation speed in an area between a side, facing toward the automated transmission, of a clutch located between a drive engine and the automated transmission, and an input shaft of the automated transmission.

31. The transmission control device according to claim 28, wherein the signal input for determining the magnitude proportional to the driving speed is connected to a rotation speed sensor, which determines and transmits to the transmission control device, a rotation speed in an area between an output shaft of the automated transmission and a driven wheel.

32. The transmission control device according to claim 28, wherein the transmission control device controls the automated transmission of the vehicle which, at full load, has a low maximum and vehicle-weight-related power.
